(19) United States
(12) Patent Application Publication
(10) Pub. No.: US 2024/0230285 A9
(43) Pub. Date: Jul. 11, 2024

(54) SECURITY SYSTEM

(71) Applicant: ROY MCMILLIAN, Bonney Lake, WA (US)

(72) Inventor: ROY MCMILLIAN, Bonney Lake, WA (US)

(21) Appl. No.: 17/972,169

(22) Filed: Oct. 24, 2022

(51) Int. Cl. F41H 11/00; B05B 13/00; G06V 40/16

(52) U.S. Cl. CPC F41H 11/00; B05B 13/00; G06V 40/168; H04N 7/183

(57) ABSTRACT

The present invention is a security system having a fluid storage tank, deterrent fluid in the tank, a fluid outlet a pump with tubing originating in said storage tank and terminating at the outlet, an actuator operatively associated with the pump a means for identifying an authorized person in an area in which said system is deployed.

### BACKGROUND OF THE INVENTION

It is a sad reality that our world continually needs evolving and sophisticated security systems. As the security systems evolve, they typically become more complex and expensive. Along with the expense comes the logistical concern of updating a system once it has been deployed. This often results in systems that are expensive complex, expensive, and difficult to operate and maintain. There is a need for an effective cost-efficient system.

The present invention addresses this need.

### SUMMARY OF THE INVENTION

It's a fair assumption that we can't keep unauthorized persons out of our stores and schools. Since we know they are present, they have likely breached security we need to take away their advantage of speed and effectiveness. A very simple motion or beam interference triggered system would spray the floor and unauthorized people (UAP) with a very slippery brightly colored substance. This would disable the unauthorized persons from moving quickly and disable them from breaking into secure display cases or hurting people. The substance would also act as a dye marker to allow their identification.

These systems have the following advantages:
1. Slow the element of rapid entry, performance of tasks and exit of unauthorized persons during robberies or school security breaches.
2. Hinder or disable thieves from developing body torque for cabinet entry or hookup to drag ATMs out of store fronts.
3. Provides difficulty of handling weapons in robberies and school invasions.
3. Allow for easy clean up after triggering system and assist in ID of unauthorized persons after leaving store or school.

Imagine a pickup truck approaching the entrance to a closed drug store. The thieves back their pickup through the entrance door to allow entry, which immediately sets off an alarm that is audible and may alert police (existing alarm). Note: This example is from an actual robbery in Lakeland Hills, Wa. As they breach, the entrance the system is triggered and starts dropping a very low viscosity, dye marked and very slippery substance onto the floor and UAP's at the entrance, strategic locations and all exits. The thieves footing is immediately affected. Confidence in their quick action is inhibited.

The substance is on their shoes and hands. Although they may remove their shoes the substance is on their hands and impedes not only their walking and physical activity, but ability to effectively grasp and use a weapon. Nevertheless, as they attempt to go about their assigned tasks, they've wasted valuable time. As goods are carried out of the store, once again the substance is encountered. A short time after the system is triggered on entry it once again begins dropping the substance in a curtain pattern at the entrance, exits and strategic floor locations. At some time after the incident, the substance turns into a rubbery and peelable material and is mostly on the floor. Cleanup is quick and relatively easy. The substance will be non-toxic.

The delivery assembly would contain control electronics and WIFI capabilities. The assembly would have to be manufactured from sheet metal and have a neutral appearance to not solicit questions as to its function. The nozzle assembly will have market ready parts for assembly. Some sheet metal work, silver soldering, electronics, and mechanical assembly and welding would be required.

Recovery from deploying the system is quick and can be back online in hours. The system would cause a local mess that has to be cleaned up, the tank refilled, and an operational system check without dispensing fluid would be required to bring the system back online. Clean up can be accomplished with a detergent and water.

The system is inexpensive. Information from the WEB shows school districts are spending millions on school security systems. For instance, Atlanta spent 9.2 million. This system will not require expensive software and is mostly analog with digital interfaces to indicators and logic circuits for status displays. Installation would be quick, and some sense of security would be in place quickly in smaller elementary schools.

There are no known systems of this nature to compare to. Most systems are configured for keeping unauthorized people (UAP) off campus and out of classrooms. This system is a failsafe system that assume perimeter security has failed as it has time and time again.

The cost of this system will be:
Less than $2000 per dispensing unit, and another $1000 for sensors and indicator panels×the number of classrooms (10)+3000 for the hallway dispensers and sensors+op program=approximately $60,000. A simple program perhaps an app. would be required to run WIFI components and operations appx. $200. A 10-room schoolhouse with a common hallway installation would cost about $30,500+labor. Production costs (unknown). Note: The program is a onetime expenditure per site. All costs are approximate.

The basic model would use existing cameras for status.

In one embodiment, a security person on a school campus will have a status panel in front of them on their computer or cell phone and be looking at the perimeter and hallway cameras all the time. There are camera monitors at the front office and/or selectable from computers throughout the school via WIFI with secure logins.

In one embodiment, the invention is a security system, said system comprising:
a fluid storage tank;
deterrent fluid in said fluid storage tank;
an outlet
a pump and tubing, said tubing originating in said storage tank and terminating at said outlet;
an actuator operatively associated with said pump; and
a means for identifying an authorized person in an area in which said system is deployed.

In one embodiment, the deterrent fluid imparts a low coefficient of static friction on surfaces applied rendering them slippery.

In one embodiment, the deterrent fluid contains a non-water-soluble dye.

In one embodiment, the outlet is a deterrent fluid ejector.

In one embodiment, the outlet is a deterrent fluid ejector configured with one or more rotatable nozzles.

In one embodiment, the actuator is initiated by a person being a system operator in response to an unauthorized person.

In one embodiment, the actuator is initiated by a panic button in response to an unauthorized person.

In one embodiment, the system is including one or more cameras.

In one embodiment, the actuator is initiated by an automatic identifier utilizing facial recognition software operatively associated with a camera deployed with said system.

In one embodiment, the is including a control station for monitoring and deploying said system.

In one embodiment, the control station is wirelessly connected to said system.

In one embodiment, the invention is a security system, said system consisting of:
a fluid storage tank;
deterrent fluid in said fluid storage tank;
an outlet
a pump and tubing, said tubing originating in said storage tank and terminating at said outlet;
an actuator operatively associated with said pump; and
a means for identifying an authorized person in an area in which said system is deployed, and is further defined by any one or combination of elements provided herein.

### BRIEF DESCRIPTION OF THE SEVERAL VIEWS OF THE DRAWINGS

FIG. 1 the system deployed in a classroom according to one embodiment of the present invention.

FIG. 2 the system deployed in a retail store according to one embodiment of the present invention.

FIG. 3 the system deployed in a jewelry store according to one embodiment of the present invention.

FIG. 4 is a top view of the fluid spray system according to one embodiment of the present invention.

FIG. 5 is an end view of the fluid spray system according to one embodiment of the present invention.

FIG. 6 is a front view of the fluid spray system according to one embodiment of the present invention.

FIG. 7 is a master controller according to one embodiment of the present invention.

FIG. 8 is a classroom status panel according to one embodiment of the present invention.

FIG. 9 is an operational flow chart according to one embodiment of the present invention.

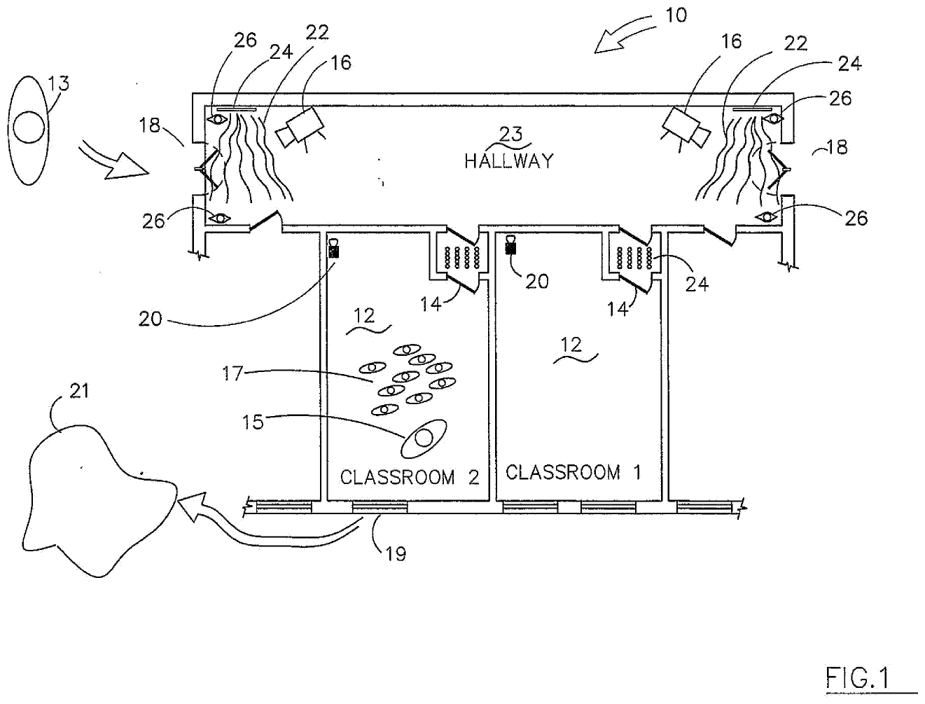

### DETAILED DESCRIPTION OF THE PREFERRED EMBODIMENTS

Although the drawings depict a particularized embodiment, the present invention is contemplated as configurable in any physical structure whereby the inventive scope and concept are achieved.

System 10 is deployed in classroom 12. Unauthorized person 13 is depicted in figure one as entering classroom 12 through entrance door 18. Camera 18 differentiates between teacher 15 student 17 and unauthorized person 13. In one embodiment, the system is monitored by a system administrator. In another embodiment, authorized persons such as teachers, students, and others are prescreened utilizing either facial recognition software operatively associated with camera at 16 or by carrying a physical badge in which system 10 identifies an authorized person.

In embodiment of the present invention hallway door 23 leads to double entry door 14 in which authorized enters a classroom. Alert indicators 20 are audio, visual, or combination alerts that indicate the system has been actuated. Upon activation of an alert, authorized persons will be directed to a safe zone 21 predetermined upon deploy of the system.

The system further includes sensors 26 which, when utilized with cameras 16 can monitor motion of an unauthorized person 13. The system further includes supply tank 34 in which deterrent fluid 22 is stored. Fluid pump 36 is operatively associated with supply take 34 and ejectors 24. The system being constructed in a range to eject deterrent fluid 22 on an unauthorized person 13. In one embodiment, system 10 is configured with a rotating spray nozzle 38 in which deterrent fluid 22 is dispersed in a wider area.

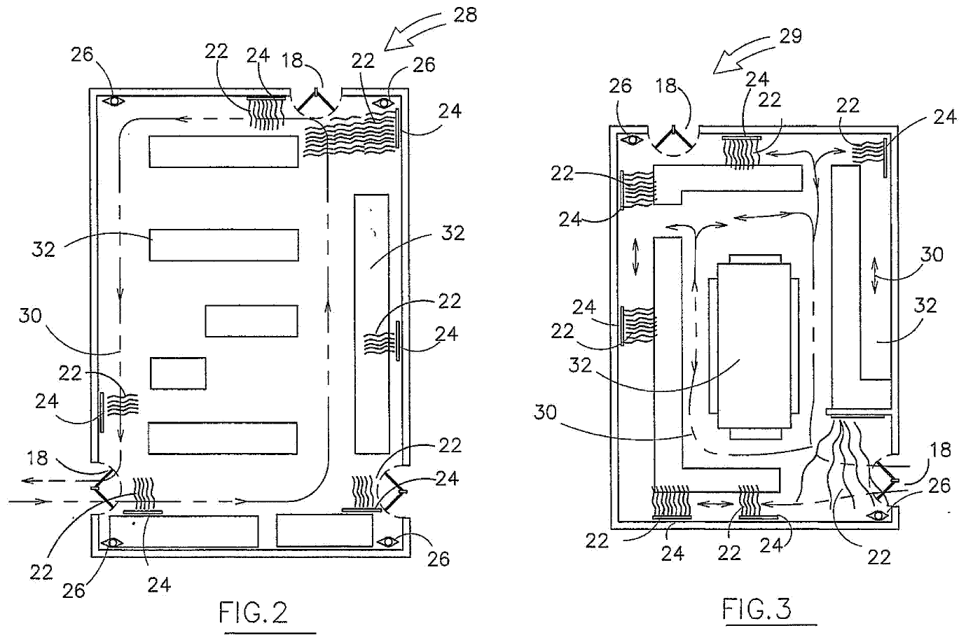

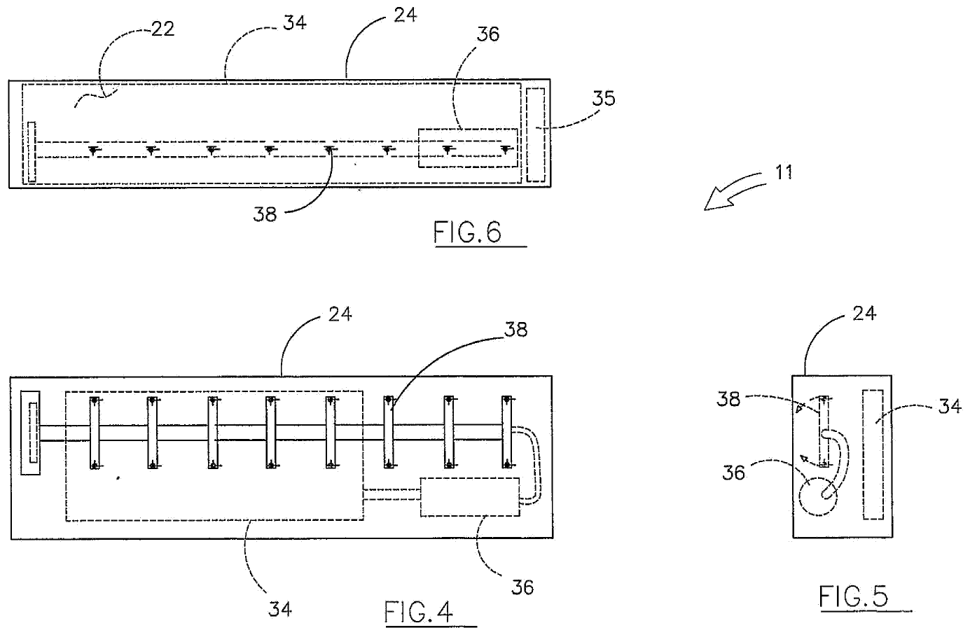

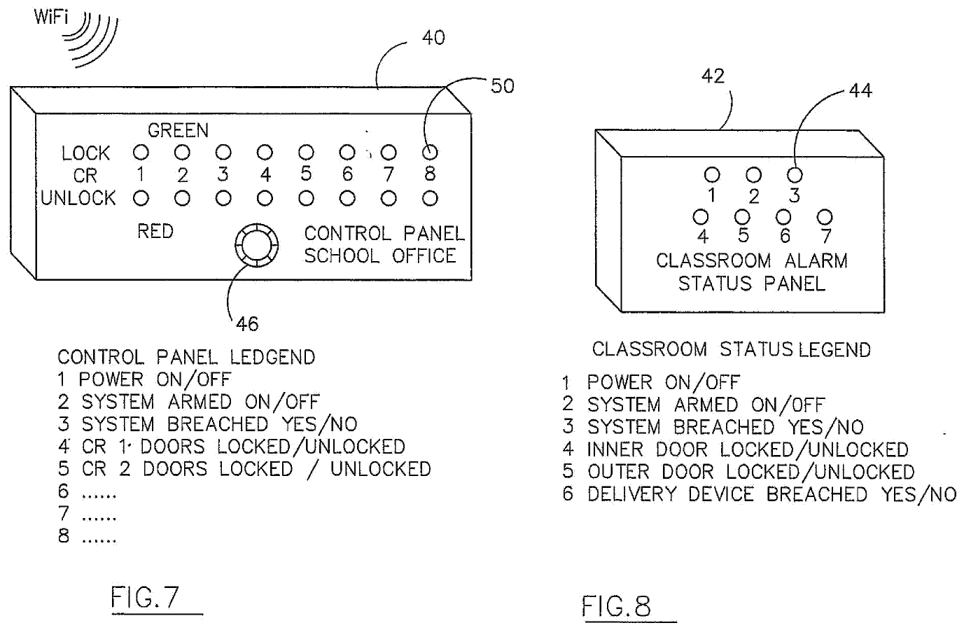

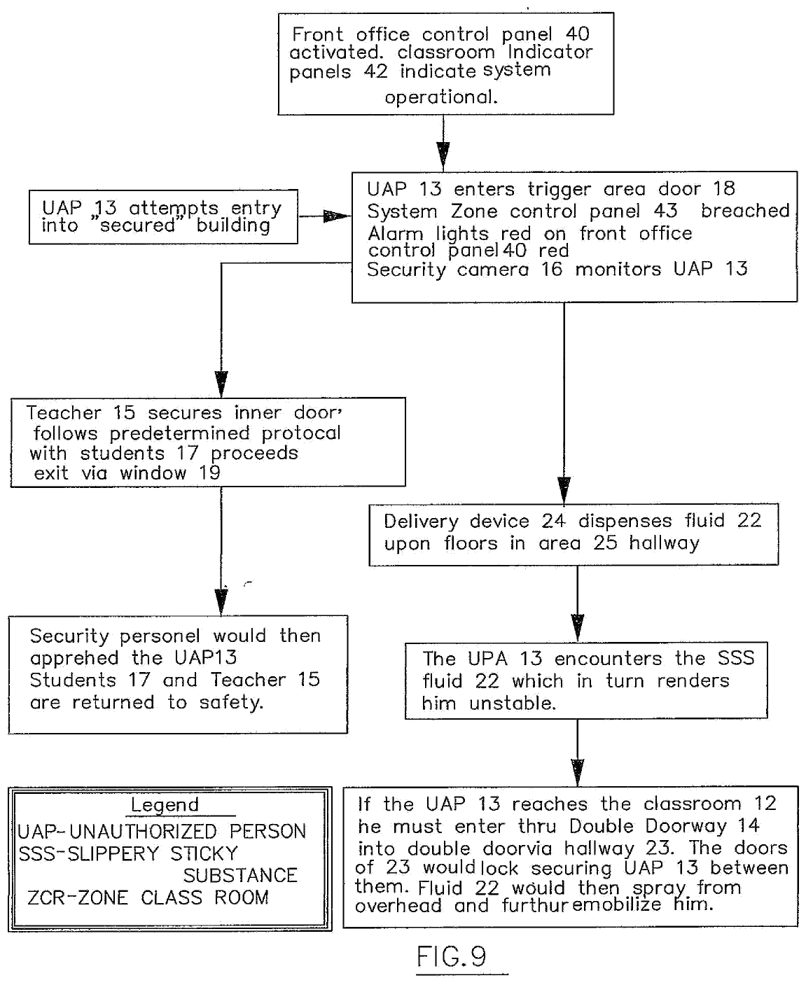

In the embodiment of FIG. 2, a typical drug store 28 is depicted utilizing the system of the present invention. In this configuration, pedestrian traffic has 30 about store displays 32 are shown.

In the embodiment of FIG. 3, a typical jewelry store 29 is depicted again with a proposed layout of components of the present invention.

Control panel 40 includes operational controls and a site monitor selector 46. Zone control panel 42 provides indicia 44 relating to current system status.

As generally understood, and unauthorized person 13 enters an unauthorized area monitored by system 10 of the present invention. The system is actuated either by a system operator or by an automated identification process in response to an authorized person entering the area. Upon activation, fluid 22 contains in supply tank 34 is pumped by fluid pump 36 to an outlet, being ejector 24. As already noted, in one body, ejector 24 may further include one or more rotating spray nozzles 38 in order to disperse the fluid in a wider area. The fluid of the system is contemplated as a non-lethal response to an unauthorized person 13. The fluid will make continual movement in the actuated area very difficult for the unauthorized person 13.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A security system, said system comprising:
a fluid storage tank;
deterrent fluid in said fluid storage tank;
an outlet
a pump and tubing, said tubing originating in said storage tank and terminating at said outlet;
an actuator operatively associated with said pump; and
a means for identifying an authorized person in an area in which said system is deployed.

2. The system of claim 1 wherein said deterrent fluid imparts a low coefficient of static friction on surfaces applied rendering them slippery.

3. The system of claim 1 wherein said deterrent fluid contains a non-water-soluble dye.

4. The system of claim 1 wherein said outlet is a deterrent fluid ejector.

5. The system of claim 1 wherein said outlet is a deterrent fluid ejector configured with one or more rotatable nozzles.

6. The system of claim 1 wherein said actuator is initiated by a person being a system operator in response to an unauthorized person.

7. The system of claim 1 wherein said actuator is initiated by a panic button in response to an unauthorized person.

8. The system of claim 1 including one or more cameras.

9. The system of claim 1 wherein said actuator is initiated by an automatic identifier utilizing facial recognition software operatively associated with a camera deployed with said system.

10. The system of claim 1 including a control station for monitoring and deploying said system.

11. The system of claim 10 where said control station is wirelessly connected to said system.
